(19) United States
(12) Patent Application Publication
(10) Pub. No.: US 2005/0231695 A1
(43) Pub. Date: Oct. 20, 2005

(54) Method and system for immersion lithography using high PH immersion fluid

(75) Inventors: Chao -Hsiung Wang, Hsinchu (TW); Horng-Huei Tseng, Hsin-chu (TW)

Correspondence Address: DUANE MORRIS LLP;IP DEPARTMENT (TSMC), 4200 ONE LIBERTY PLACE, PHILADELPHIA, PA, 19103-7396, US

(73) Assignee: Taiwan Semiconductor Manufacturing Company, Ltd.

(21) Appl. No.: 10/824,750

(22) Filed: Apr. 15, 2004

(51) Int. Cl. G03B 27/42

(52) U.S. Cl. 355/53

(57) ABSTRACT

A method and system is disclosed for conducting immersion photolithography. The system includes at least one lens for transmitting a predetermined radiation on a predetermined product substrate, and a fluid volume in contact with the lens on its first end and with the product substrate on its second end, wherein the fluid volume has a molar concentration of hydroxyl ions more than 10⁻⁷ mole per liter.

### BACKGROUND

The present disclosure relates generally to immersion lithography processes used for the manufacture of semiconductor devices, and more particularly to the immersion lens fluids used within the immersion lithography systems.

The manufacture of very large-scale integrated (VLSI) circuits requires the use of many photolithography process steps to define and create specific circuits and components onto the semiconductor wafer (substrate) surface. Conventional photolithography systems comprise of several basic subsystems such as a light source, optical transmission elements, transparent photo mask reticles, and electronic controllers. These systems are used to project a specific circuit image, defined by the mask reticle, onto a semiconductor wafer coated with a light sensitive film (photoresist) coating. As VLSI technology advances to higher performance, circuits become geometrically smaller and denser, requiring lithography equipment with lower resolution projection and printing capability. Such equipment is required to be capable of resolutions lower than 100 nanometers (nm). As new device generations are developed requiring even further improvements, of feature resolutions 65 nm and lower, major advancements to photolithography processing were required.

Immersion lithography has been implemented to take advantage of the process technology's capability for much improved resolution. Immersion lens lithography features the usage of a liquid medium to fill the entire gap between the last objective lens of the light projection system and the semiconductor wafer (substrate) surface during the light exposure operations of the photoresist pattern printing process. The liquid immersion medium of the immersion lens lithographic technique provides an improved index of refraction for the exposing light, thus improving the resolution capability of the lithographic system. This is shown with the Rayleigh Resolution formula, R=kλ/N.A., where R (resolution) is dependant upon k (certain process constants), λ (wavelength of the transmitted light) and the N.A. (Numerical Aperture of the light projection system). It is noted that N.A. is a function of the index of refraction, N.A.=n sin θ where n is the index of refraction of the liquid medium between the objective lens and the wafer substrate, and θ is the acceptance angle of the lens for the transmitted light.

It can be seen that as the index of refraction (n) becomes higher for a fixed acceptance angle, the numerical aperture (N.A.) of the projection system becomes larger, thus providing a lower resolution (R) capability for the lithographic system. Conventional immersion lithographic systems utilize de-ionized water as the immersion lens fluid between the objective lens and the wafer substrate. De-ionized water at 20 degree Celsius has an index of refraction at approximately 1.33 versus air which has an index of refraction at approximately 1.00. It can be seen that immersion lithographic systems, utilizing de-ionized water as the immersion lens fluid, offer much improvement to the resolution capability of the photolithography processes.

FIG. 1 is a cross-sectional diagram that illustrates the typical immersion lithography process. The immersion printing section 100 of the lithography system shows a wafer substrate 102 with a layer of photoresist 104 coated on top of the wafer substrate. A fluid volume containing the de-ionized water immersion fluid 106 is shown located on top of the photoresist layer 104 displacing the entire volume of space between the photoresist and the last objective lens 108 of the immersion lithographic system. The objective lens 108 may be made of materials such as silicon oxide, calcium fluoride, or any other materials providing the same function. The water immersion fluid is in direct contact with both the top surface of the photoresist layer 104 and the lower surface of the objective lens 108. It is noted that if a photoresist protective layer (not shown) is used, it would be located between the top surface of the photoresist layer 104 and in direct contact to the water immersion fluid 106. The large downward arrow 110 of FIG. 1 located above the lithography system's last objective lens 108 represents the direction of and the transmission of the pattern image-exposing light towards the objective lens and through the immersion lens fluid 106.

The use of de-ionized water as the immersion fluid in typical immersion lithography systems imposes certain concerns for the process operations. The photoresist layer 104 on top of the wafer substrate 102 may have certain tendencies to outgas, producing gas micro-bubbles within the water immersion fluid 106 during the photolithographic printing enough to distort the printed pattern and disturb the contrast of the printed images. The applied photo energy upon the photoresist layer 104 during the light exposing printing process may also induce the dissociation and migration of the inherent acid molecules held within the photoresist layer, out into the water immersion fluid 106. Dissociated acid ions in the water immersion fluid 106 may then begin to attack and etch/corrode the components of the lithography objective lens 108 (usually comprised of calcium fluoride and/or silicon dioxide) as well as to the surface of the photoresist layer 104. Acid corrosion to the lens 108 and to the photoresist pattern 104 may lead to distorted and poorly printed images. In addition, the de-ionized water itself may be corrosive to both, the objective lens 108 and to the photoresist layer 104.

To help prevent and minimize such corrosion effects produced by the migrating water and acid ions from and onto the photoresist layer, certain semiconductor manufacturing technologies may implement an additional, thin transparent protective layer on top of the photoresist layer. Such protective layer serves as a mechanical barrier during the immersion photo printing processing to suppress and possibly stop the migrating water, micro-bubbles, and acid ions. Such method of protection is effective only to a certain extent. The method also requires additional production materials, production equipment, invested labor and time costs to implement within the manufacturing facilities and operations. It is also noted that the use of the protective layer on the photoresist does not address the issues with the corrosion of the lithography equipment's objective lens by the water and the inherent acid ions within the water immersion fluid.

FIGS. 2a through 2c illustrate the corrosion concerns associated with water and acid attack upon the objective lens and photoresist. FIG. 2a is a cross-sectional diagram 200 showing close views of the water immersion fluid 202 and the fluid's interfaces to the contacted objective lens 204 and to the contacted photoresist layer 206 of the wafer substrate. The water immersion fluid 202 is in direct contact to the lowest surface of the objective lens 204 at the interface labeled 208 on the diagram. The water immersion fluid 202 is in direct contact to the top surface of the photoresist (or photoresist protective) layer 206 at the interface labeled 210 on the diagram. Intact, whole water molecules, H₂O, and dissociated water ions, H⁺ (hydrogen) and OH⁻ (hydroxyl), are shown located within the immersion fluid layer 202. Intact, whole acid molecules HA are shown located within the photoresist layer 206. (The designation of intact acid molecules as HA is shown as such, whereas the H symbol represents the bound hydrogen anion component, and the A symbol represents the bound acid cation component of the acid.) The balanced chemical and ion representations within the water immersion fluid 202 and the photoresist layer 206 of FIG. 2a illustrate the chemical locations before any corrosion mechanism has started.

FIG. 2b is a cross-sectional diagram similar to FIG. 2a. FIG. 2b illustrates the corrosion mechanism by which a certain quantity of the water immersion fluid 202 migrates across the immersion fluid, photoresist interface 210 into the photoresist layer 206. The water molecules, H₂O, interact with the acid molecules, HA, to break and dissociate the acid molecules into its ionic components, H⁺ and A⁻. This dissociation process may be enhanced and catalyzed by the energy provided by the exposing light 212 of the photolithographic system. The free acid anions, H⁺, may subsequently migrate within the system 200 to cause the corrosion issues. It is also noted that the migration and movement of molecules and ions across the immersion fluid, photoresist interface 210 may cause dynamic changes to the index of refraction of the water immersion fluid 202. Such changes to the index of refraction may be very difficult to characterize and control, due to a graded index of refraction within, in addition to the dynamically changing index of the immersion fluid. This uncontrollability may lead to poor resolution performance of the immersion lithography system resulting in poor patterns and distorted printed images.

FIG. 2c is another cross-section diagram similar to FIGS. 2a and 2b. FIG. 2c illustrates how the dissociated acid anion components H⁺ migrates from the photoresist layer 206, across the photoresist, immersion fluid interface 210, into the water immersion fluid 202. The acid anions H⁺ may cause corrosion of the photoresist (or photoresist protective layer) surface 206 at the photoresist, immersion fluid interface 210. The acid anions H⁺ that have migrated into the water immersion fluid 202 may also migrate to the immersion fluid, objective lens interface 208. Acid anions at the immersion fluid, objective lens interface 208 may begin to corrode the surface of the objective lens 204. Again, these dissociation and corrosion processes may also be enhanced and catalyzed by the energy provided by the exposing light 212 of the photolithographic system. The larger the numerical aperture (N.A.) of the objective lens 204, the easier for the lens corrodes to happen, especially when the N.A. of the objective lens is larger than 0.75.

What is desired is an improved method for the control and specification of the immersion fluid properties such that the fluids induce minimal or no corrosion of the lithographic objective lens and photoresist layers. Such immersion fluids would control and suppress the dissociation and migration of acid ions from the photoresist layer into the immersion fluid. The immersion fluid would remain chemically stable such that the fluid's index of refraction remains constant and uniform within its entire displacement volume.

### SUMMARY

In view of the foregoing, this disclosure provides a method and system for conducting immersion photolithography.

In one example, the system includes at least one lens for transmitting a predetermined radiation on a predetermined product substrate, and a fluid volume in contact with the lens on its first end and with the product substrate on its second end, wherein the fluid volume has a molar concentration of hydroxyl ions more than 10⁻⁷ mole per liter.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a cross-sectional view of the typical immersion lithography process.

FIGS. 2a through 2c illustrate cross-sectional views of the typical immersion lithography process with the locations and movements of the various chemical molecules and ions before and during the immersion lithography processes.

FIGS. 3a through 3c illustrate cross-sectional views of the disclosed immersion lithography process with the locations and movements of the various chemical molecules and ions before and during the immersion lithography processes.

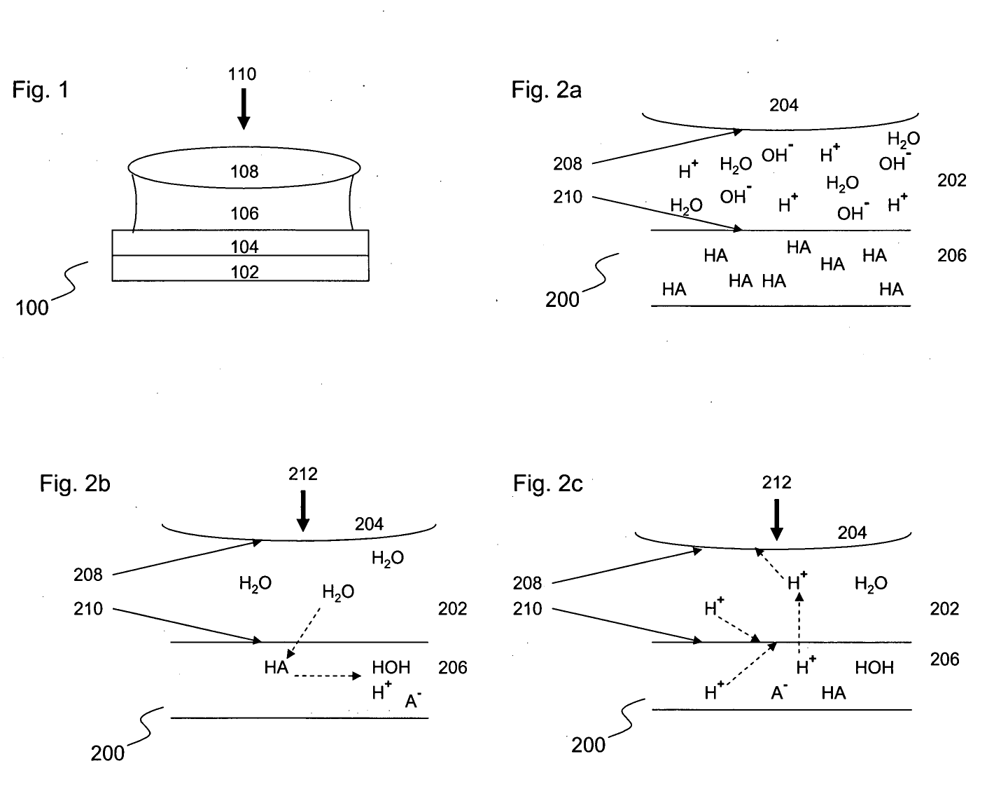

### DESCRIPTION

The present disclosure describes an improved method for the control and specification of the immersion fluid properties used within immersion lithography systems. The disclosed method specifies immersion fluids that are inherently high in OH⁻ (hydroxyl) ions, to greatly reduce and stop the corrosion of the lithographic objective lens and wafers' photoresist layers. Such disclosed immersion lens fluids control and suppress the dissociation and migration of acid ions across the immersion fluid, photoresist interface as well as to help stabilize the immersion fluid's index of refraction.

It is understood that, in practice, there are various ways to conduct an immersion lithography process. In general, when the fluid volume with an appropriate chemical combination is selected, a product substrate such as a wafer coated with some light sensitive materials is brought to be in contact with the fluid volume. The fluid volume is in contact with an objective lens on another end. The lithography system's radiation source will provide an electromagnetic radiation in a predetermined form such as light with a predetermined wavelength to be transmitted through the lens and the fluid volume so that the product substrate is exposed to such radiation.

The immersion lens fluid of the present disclosure features fluids with high concentrations of OH⁻ (hydroxyl) ions in an aqueous solution. The high OH— concentration reduces the relative levels of H⁺ (hydrogen) acid anions held within the immersion fluid. The disclosed immersion fluid may also be known as a chemical aqueous base solution with which chemical properties are of a pH value greater than 7 and which the molar concentration of the OH⁻ (hydroxyl) ions within the fluid are greater than 10⁻⁷ moles per liter. In some examples, the range of the molar concentration can be further limited to a range between about 10⁻⁷ and about 10⁻¹ mole per liter, or a further narrower range in between such as a range between about 10⁻⁵ and about 10⁻³ mole per liter or a range between about 10⁻⁵ and about 10⁻⁷ mole per liter. It is noted that such disclosed immersion lens fluids also feature high index of refraction, similar to or better than that of de-ionized water, sufficient for use as the resolution improving immersion fluid medium of the immersion lithography systems. Specifically, the immersion fluids of the present disclosure may include such chemical solutions as NaOH (sodium hydroxide), CaOH (calcium hydroxide), and/or KOH (potassium hydroxide).

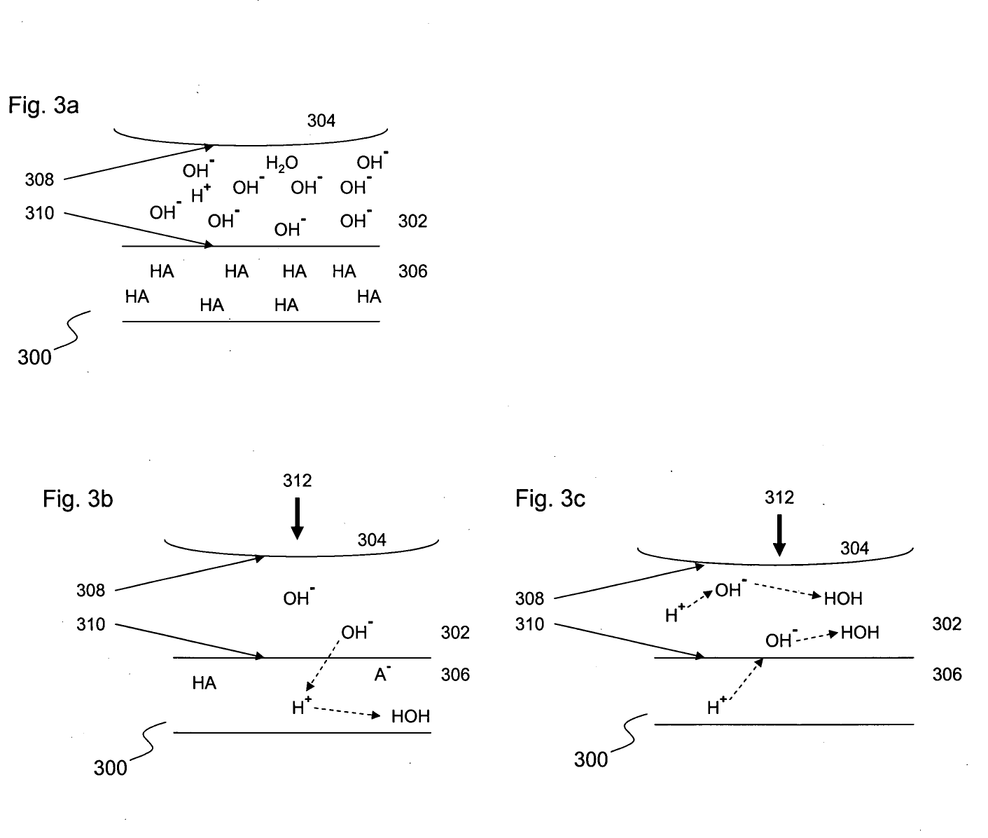

FIGS. 3a through 3c illustrate cross-sectional views of the disclosed immersion lithography process utilizing fluids featuring high OH⁻ (hydroxyl) ion concentrations. FIG. 3a is a cross-sectional diagram 300 showing close views of the water immersion fluid 302 and the fluid's interfaces to the contacted objective lens 304 and to the photoresist (or photoresist protective) layer 306 of the wafer substrate. The water immersion fluid 302 is in direct contact to the lowest surface of the objective lens 304 at the interface labeled 308 on the diagram. The water immersion fluid 302 is in direct contact to the top surface of the photoresist (or photoresist protective) layer 306 at the interface labeled 310 on the diagram. Intact, whole water molecules, H₂O, dissociated water ions, H⁺ (hydrogen) and OH⁻ (hydroxyl), and additional excess OH⁻ (hydroxyl) ions are shown located within the immersion fluid layer 302. Intact, whole acid molecules HA are shown located within the photoresist layer 306. The balanced chemical and ion representations within the water immersion fluid 302 and the photoresist layer 306 of FIG. 3a illustrate the chemical locations before any molecular and ion migration mechanisms have started.

FIG. 3b is a cross-sectional diagram similar to FIG. 3a. FIG. 3b illustrates the migration of the highly concentrated OH⁻ (hydroxyl) ions from the disclosed immersion fluid 302 into the photoresist layer 306 to react with any free, dissociated acid anions, H⁺, which may be located with the photoresist layer 306. The OH⁻ (hydroxyl) ions migrates from the immersion fluid 302, through the immersion fluid, photoresist interface 310 to combine with any free H⁺ acid anions to form neutral water, H₂O (or HOH), molecules. The water molecules and the residual acid A⁻ cations will remain suppressed within the photoresist layer 306. As result, the availability of free acid H⁺ anions to corrode the immersion fluid, photoresist (or photoresist protective layer) interface 310 and immersion fluid, objective lens interface 308 is greatly diminished.

FIG. 3c is another cross-section diagram similar to FIGS. 3a and 3b. FIG. 3c illustrates how the excess OH⁻ (hydroxyl) ions from the disclosed immersion fluid 302 interacts with any dissociated water components, H⁺ (hydrogen) and OH⁻ (hydroxyl) and/or any dissociated acid H⁺ anion components located within the disclosed immersion fluid 302. The free OH⁻ (hydroxyl) ions will combine with the free H⁺ ions to form neutral water, H₂O (or HOH), molecules. As result, the disclosed immersion fluid 302 remains low in H⁺ acid anion concentration. FIG. 3c also illustrates the situation when free H⁺ acid anions originating from within photoresist layer 306 reaches the disclosed immersion fluid, photoresist layer interface 310. The free H⁺ acid anion upon reaching the interface 310, will interact with free OH⁻ (hydroxyl) ions to form neutral water, H₂O (or HOH), molecules.

Through the disclosed method of using chemically specified basic solutions as the immersion lens fluids of immersion lithography systems, the corrosion concerns of the lithography objective lens and photoresist (and photoresist protective) layers may be greatly controlled and minimized. The reduction of free H⁺ ions and the excess of OH⁻ (hydroxyl) ions within the disclosed immersion lens fluid will suppress the dissociation and migration of acid ions from the photoresist layer into the immersion fluid. Such control and minimization of acid anion movement will greatly reduce and minimize the corrosion of the photoresist pattern surface as well as the lithographic equipment. There would be less need for the implementation of cost and time consuming process technologies for a photoresist protective layer. Such disclosed immersion lens fluids are also chemically stable such that the fluid's index of refraction remains constant and uniform within its entire displacement volume.

The disclosed method and pH, molarity specified immersion lens fluid may be easily implemented into existing device process designs and flows as well as into their fabrication facilities and operations. The method and immersion lens fluid of the present disclosure may also be implemented into present advanced technology immersion lithography systems utilizing 193 nm to 248 nm exposing light wavelengths, as well as systems utilizing 193 nm or shorter light wavelengths such as those around or shorter than 157 nm. In addition, the N.A. of the objective lens may be between 0.75 and 0.85, and in some embodiments, between 0.85 and 1.05. The benefits provide by the disclosed methods and specified immersion lens fluid will allow for advanced technology semiconductor devices of high reliability, high performance and high quality. Such improvements will translate into significant cost improvements for a given production facility to maintain highly competitive cost and output advantages over other manufacturers of similar product devices.

The above disclosure provides many different embodiments or examples for implementing different features of the disclosure. Specific examples of components and processes are described to help clarify the disclosure. These are, of course, merely examples and are not intended to limit the disclosure from that described in the claims.

Although the invention is illustrated and described herein as embodied in a design and method for immersion lithography using high PH fluid, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the disclosure, as set forth in the following claims.

1. A photolithography system comprising:
at least one lens for transmitting a predetermined radiation on a predetermined substrate; and
a fluid volume in contact with the lens on its first end and with the substrate on its second end,
wherein the fluid volume has a molar concentration of hydroxyl ions more than 10⁻⁷ mole per liter.

2. The system of claim 1 further comprising a radiation source providing an electromagnetic radiation with a wavelength of about 193 nm or less.

3. The system of claim 1 further comprising a radiation source providing an electromagnetic radiation with a wavelength of about 157 nm or less.

4. The system of claim 1 wherein the lens has a numerical aperture size between about 0.75 and 0.85.

5. The system of claim 1 wherein the lens has a numerical aperture size between about 0.85 and 1.05.

6. The system of claim 1 wherein the lens is made of silicon oxide.

7. The system of claim 1 wherein the lens is made of calcium fluoride.

8. The system of claim 1 wherein the fluid volume includes water.

9. The system of claim 1 wherein the fluid volume includes metal hydroxide.

10. The system of claim 1 wherein the molar concentration of hydroxyl ions is less than about 10⁻¹ mole per liter.

11. The system of claim 1 wherein the molar concentration of hydroxyl ions is between about 10⁻³ mole and about 10⁻⁵ mole per liter.

12. The system of claim 1 wherein the molar concentration of hydroxyl ions is between about 10⁻⁵ mole and about 10⁻⁷ mole per liter.

13. The system of claim 1 wherein the substrate has a radiation sensitive material.

14. The system of claim 1 wherein the substrate is a semiconductor substrate material with a photoresist material formed thereon.

15. A photolithography system comprising:
a radiation source providing an electromagnetic radiation with a wavelength of about 193 nm or less;
at least one lens for transmitting a predetermined radiation from the radiation source on a predetermined substrate; and
a fluid volume in contact with the lens on its first end and with the substrate on its second end,
wherein the fluid volume has a molar concentration of hydroxyl ions between about 10⁻⁷ mole per liter and about 10⁻¹ mole per liter.

16. The system of claim 15 wherein the lens has a numerical aperture size between about 0.75 and 0.85.

17. The system of claim 15 wherein the lens has a numerical aperture size between about 0.85 and 1.05.

18. The system of claim 15 wherein the lens is made of silicon oxide.

19. The system of claim 15 wherein the lens is made of calcium fluoride.

20. The system of claim 15 wherein the fluid volume includes de-ionized water.

21. The system of claim 15 wherein the molar concentration of hydroxyl ions is between about 10⁻³ mole per liter and about 10⁻⁵ mole per liter.

22. The system of claim 15 wherein the molar concentration of hydroxyl ions is between about 10⁻⁵ mole per liter and about 10⁻⁷ mole per liter.

23. The system of claim 15 wherein the substrate has a radiation sensitive material formed thereon.

24. The system of claim 15 wherein the substrate is a semiconductor substrate material with a photoresist material formed thereon.

25. The system of claim 15 wherein the fluid volume includes NaOH in an aqueous solution.

26. The system of claim 15 wherein the fluid volume includes CaOH in an aqueous solution.

27. The system of claim 15 wherein the fluid volume includes KOH in an aqueous solution.

28. A method for conducting immersion photolithography, the method comprising:
placing a substrate to be in contact with a fluid volume on its first end;
placing at least one lens in contact with the fluid volume on its second end; and
providing an electromagnetic radiation with a wavelength of about 193 nm or less for transmitting a predetermined radiation through the lens on a predetermined substrate,
wherein the fluid volume has a molar concentration of hydroxyl ions more than about 10⁻⁷ mole per liter.

29. The method of claim 28 wherein the fluid volume includes water.

30. The method of claim 28 wherein the lens has a numerical aperture size between about 0.75 and about 0.85.

31. The method of claim 28 wherein the molar concentration of hydroxyl ions is between about 10⁻³ mole per liter and about 10⁻⁵ mole per liter.

32. The method of claim 28 wherein the molar concentration of hydroxyl ions is between about 10⁻⁵ mole per liter and about 10⁻⁷ mole per liter.

33. The method of claim 28 wherein the substrate is a semiconductor substrate material with a photoresist material formed thereon.
